(19) United States
(12) Patent Application Publication
(10) Pub. No.: US 2026/0126018 A1
(43) Pub. Date: May 7, 2026

(54) METHOD AND DEVICE FOR OPERATING AN INTERNAL COMBUSTION ENGINE USING HYDROGEN

(71) Applicant: Robert Bosch GmbH, Stuttgart (DE)

(72) Inventors: Holger Kauss, Wernau (DE); Michael Lippisch, Vaihingen An Der Enz (DE); Oezguer Tuerker, Gerlingen (DE); Thomas Burtsche, Weinstadt (DE)

(21) Appl. No.: 19/365,273

(22) Filed: Oct. 22, 2025

(30) Foreign Application Priority Data
Nov. 4, 2024 (DE) 10 2024 210 580.5

(51) Int. Cl. F02D 41/00; F02D 41/14; F02D 41/40

(52) U.S. Cl. CPC F02D 41/0027; F02D 41/401; F02D 41/1498

(57) ABSTRACT

A method and a device for operating an internal combustion engine using hydrogen. The hydrogen is injected directly into the combustion chamber of the internal combustion engine. The hydrogen is injected in an angular range later than 40° of crankshaft angle after the closing of an air inlet valve of the internal combustion engine.

### BACKGROUND INFORMATION

Certain methods and devices for operating an internal combustion engine using hydrogen are available, in which hydrogen is injected directly into the combustion chamber of the internal combustion engine. Corresponding internal combustion engines and valves for injecting hydrogen directly into the combustion chamber of the internal combustion engine are described in Germany Patent Application No. DE 10 2023 206 011.

### SUMMARY

A method according to the present invention and a device according to the present invention, by contrast, have an advantage that improved operation of the internal combustion engine is made possible. In particular, knocking combustion in the internal combustion engine is avoided, which allows for more efficient operation of the internal combustion engine.

Further advantages and improvements result from the measures of example embodiments of the present invention described herein. By selecting the latest possible angular range for injection, the operation of the internal combustion engine, in particular the knock susceptibility of the internal combustion engine, is improved. By taking into account the pressure in the combustion chamber due to compression, the optimal angular range for injection is optimized. For this optimization, the amount of hydrogen injected and the center of combustion are also advantageously taken into account. The center of combustion may be influenced in particular by selecting a suitable ignition angle.

The aforementioned measures optimize the knock susceptibility of the internal combustion engine.

Exemplary embodiments of the present invention are illustrated in the figures and explained in more detail in the following description.

### BRIEF DESCRIPTION OF THE DRAWINGS

FIG. 1 is a schematic view of an internal combustion engine.

FIG. 2 is a characteristic map of knock susceptibility plotted against the hydrogen injection angle.

### DETAILED DESCRIPTION OF EXAMPLE EMBODIMENTS

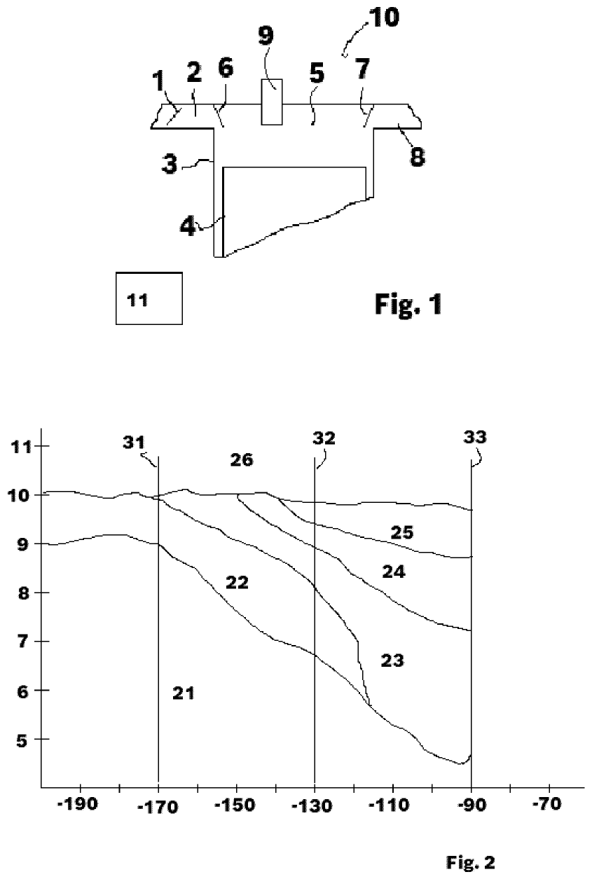

FIG. 1 is a schematic view of a hydrogen-powered internal combustion engine 10 having a cylinder 3 in which a piston 4 is arranged. Above the piston 4, the cylinder 3 forms a combustion chamber 5 into which a mixture of hydrogen and air is introduced and combusted. The combustion of the hydrogen-air mixture in the combustion chamber 5 increases the pressure in the combustion chamber 5 and the pressure is converted into mechanical work by means of a movement of the piston 4 in the cylinder 3, by means of a connecting rod (not shown here) and a crankshaft. Thus, it is a generally conventional Otto internal combustion engine.

To supply air into the combustion chamber 5, an intake pipe 2 is provided in which the amount of supplied air is controlled by a throttle valve 1. By opening and closing the throttle valve 1, the amount of air introduced into the combustion chamber 5 is controlled. Furthermore, an injection valve 9 is provided through which the hydrogen is injected directly into the combustion chamber 5. The mixture of hydrogen and air in the combustion chamber 5 is ignited by a spark plug not shown in the drawing. To remove the exhaust gases after combustion, an exhaust pipe 8 is provided through which the combusted exhaust gases are transported out of the combustion chamber 5. Furthermore, an air inlet valve 6 and an exhaust outlet valve 7 are shown schematically in FIG. 1. By opening and closing the air inlet valve 6 and the exhaust outlet valve 7, the combustion chamber 5 is connected to the intake pipe 2 or to the exhaust pipe 8, depending on the operating phase of the internal combustion engine 10. To control the internal combustion engine 10, a control device 11 is also shown, which generates signals for actuating the throttle valve 1 or the injection valve 9.

Such an internal combustion engine 10 is typically operated using a four-stroke process. In a first intake stroke, fresh air is sucked into the combustion chamber 5 by the opening of the air inlet valve 6 and the movement of the piston 4 from a top dead center to a bottom dead center. The movement of the piston creates a negative pressure in the combustion chamber, which causes air to be sucked in through the intake pipe 2. By opening the throttle valve 1, the amount of air introduced into the combustion chamber 5 is controlled. This is followed by a compression stroke in which the piston 4 moves from the bottom dead center back to the top dead center, thus compressing the gas in the combustion chamber 5. During this compression stroke, hydrogen is also injected through the injection valve 9 directly into the combustion chamber 5. After the compression stroke, the combustion stroke occurs, in which the mixture of hydrogen and air in the combustion chamber 5 is ignited and combusted by an ignition spark. This combustion greatly increases the pressure in the combustion chamber 5, and this pressure is converted into mechanical work by means of a movement of the piston 4 from top dead center to bottom dead center. During the combustion stroke, both the air inlet valve 6 and the exhaust valve 7 are closed. This is followed by the exhaust stroke, in which the exhaust outlet valve 7 is opened, and, due to a movement of the piston 4 from the bottom dead center to the top dead center, the exhaust gases, i.e., the waste products of the combustion, are transported out of the combustion chamber 5 through the exhaust pipe 8.

The internal combustion engine 10 is to be operated such that the greatest possible fraction of the energy released by the combustion is converted into mechanical work. An essential load-limiting aspect of engine-internal hydrogen combustion is knocking combustion and premature ignition of the hydrogen before the actual ignition time of the spark plug. A major cause that can lead to knocking combustion or premature ignition of the hydrogen is a high temperature during the combustion (knocking) or shortly before the combustion (pre-ignition). During knocking combustion, individual, unwanted flame fronts form, which can impair the flame front emanating from the spark plug and lead to unwanted pressure oscillations in the combustion chamber. These can cause a significant increase in cylinder pressure and damage the engine. If the hydrogen ignites prematurely before the ignition time, the energy conversion of the fuel takes place at a very early point in time. This means that only a very small combustion chamber volume is available for the combustion, which means that the pressure and temperature gradients are very steep. As a result, pressure and temperature rise very quickly during the combustion, which is why knocking combustion can often be observed as an accompanying phenomenon when pre-ignition occurs. One way to lower the combustion temperature in order to avoid knocking combustion or premature ignition is to introduce the hydrogen required for the combustion into the combustion chamber as late as possible. The “right” time to inject the hydrogen depends substantially on the closing of the inlet valves. The closing of the inlet valves determines the start of compression of the fresh air in the cylinder.

FIG. 2 shows the influence of the time of the injection of the hydrogen into the combustion chamber 5 and the influence of the ignition angle on an operation of a hydrogen-powered internal combustion engine, in particular with regard to the occurrence of knocking. As will be shown in more detail below, FIG. 2 shows that significant potential for reducing knocking combustion is achieved when injection begins at a crankshaft angle of 40° after the closing of the air inlet valve(s) 6. When the hydrogen is injected at later times, the potential increases further. The latest possible time for introducing the hydrogen is reached when the injection can no longer be completed due to the increasing cylinder back pressure at the end of the injection event.

The reason for the reduced knock susceptibility is substantially the reduced final compression temperature when the hydrogen is injected late. By introducing the amount of hydrogen late and having the inlet valves 6 closed during compression, the compression work performed by the piston on the entire gas mixture can be reduced. This is made possible by the fact that, when the inlet valves are closed, the fresh air in the cylinder must first be compressed and, thereafter, or as soon as the hydrogen is injected, the hydrogen likewise must be compressed by the upward movement of the piston. This means that the gas temperature of the hydrogen-air mixture is also lowered at the end of compression or shortly before the ignition time. Consequently, the combustion temperature also drops. The combustion temperature reduction results in increased resistance to knocking combustion, as fewer unwanted flame fronts can form.

The proposed operating strategy for the hydrogen-powered internal combustion engine provides for using late hydrogen injection during high-load operation in order to reduce knocking combustion and the probability of premature hydrogen ignition.

In order to prevent the unwanted and slow closing of the injection valve 9 during late injection due to increasing cylinder back pressure, a flow-optimized jet-forming cap is preferably used on the injection valve 9. The jet-forming cap designed for this purpose makes it possible to make the internal flow within a closed sleeve as loss-free as possible, so that the dynamic pressure below the nozzle needle is reduced and, at the same time, the jet can be introduced into the combustion chamber in a targeted manner. Such injection valves 9 are described in Germany Patent Application No. DE 10 2023 206 011.

FIG. 2 shows the influence of the time of the injection of the hydrogen into the combustion chamber 5 and the influence of the center of combustion on the knock susceptibility of the hydrogen-powered internal combustion engine. The X-axis shows an angular range of −190 to −70° of crankshaft angle before the top dead center of piston 4, at which the combustion occurs. The top dead center of the piston 4, at which the combustion occurs, is typically referred to as the ignition TDC. This top dead center is at angle 0. Shortly before angle 0, i.e., the ignition TDC, the ignition spark is triggered, which starts the combustion of the hydrogen-air mixture in the combustion chamber 5. However, because full development of the combustion requires a certain time delay, the center of combustion, and thus also the greatest pressure increase due to combustion, only occurs after the ignition TDC.

Because the time of the ignition spark has a significant influence on the knock susceptibility of the internal combustion engine, the center of combustion is also shown on the Y-axis in FIG. 2. The Y-axis shows an angular range of 5° to 11° after the ignition TDC for the combustion center. The center of combustion is thereby the angle at which 50% of the introduced hydrogen is combusted.

The injection time of the X-axis represents the start time of the injection. Typically, the hydrogen is injected at a pressure of several tens of bar, for example 40 bar. During high-load operation of the internal combustion engine, for example at a very low engine speed and when there is a high demand for power or torque from a user of the internal combustion engine, a large amount of hydrogen is injected, which can extend over an angular range of several tens of degrees, for example 50° of crankshaft angle. FIG. 2 shows the angle of the start of the hydrogen injection.

FIG. 2 shows different ranges for knock susceptibility. In range 21, the internal combustion engine experiences very strong knocking, which can directly lead to damage to the internal combustion engine, such that this operating range must not be used. Likewise, range 22, in which injection takes place in a value range between −170° and −130° of crankshaft angle with a combustion center of between approx. 10° and 6°, results in very strong knocking and should therefore be avoided. Likewise, range 23, having moderate combustion centers between 10° and 8°, together with simultaneous early injection before an angle of −130°, or having earlier combustion centers between 8° and 5° together with injection before −90° of crankshaft angle, exhibits a high knock susceptibility and should be avoided where possible. Range 25 exhibits a very low knock susceptibility between approx. 10° and 9° with injection later than −130° of crankshaft. Between ranges 23 and 25 lies range 24, having a moderate knock susceptibility, which can likewise be used for continuous operation of the internal combustion engine. Range 26, having combustion center angles later than 11°, reliably eliminates knocking, but has the disadvantage of reduced efficiency of the internal combustion engine and should therefore only be used if knocking of the internal combustion engine should be reliably avoided.

In FIG. 2, lines 31, 32 and 33 are drawn, which indicate three different angular ranges of the crankshaft angle. Line 31, at a crankshaft angle of minus 170°, indicates the closing time of the air inlet valve; i.e., before this time there is no injection into the combustion chamber 5. The closing time of the injection valve is followed by a range of approx. 40° of crankshaft angle in which it is very difficult to operate the internal combustion engine without knocking. Fuel is therefore advantageously injected in an angular range later than 40° of crankshaft angle. The usable range for the hydrogen injection is therefore at crankshaft angles later than 40° of crankshaft angle after the closing of the inlet valve, i.e., to the right of line 32 at minus 130° of crankshaft angle. Very late injection, in particular when a very large amount of hydrogen is to be introduced, has the problem that, due to the increase in pressure in the combustion chamber caused by the compression in the compression phase, further injection is no longer possible because the inlet valve is pressed shut, i.e., closed, by the pressure in the combustion chamber. This limit, for the start of the injection, is represented by line 33 at approx. minus 90° of crankshaft angle. The exact location of line 33 is to be understood by way of example in this case, because the exact location of limit 33 naturally also depends on the amount of hydrogen for injection. In the case of very small amounts, the injection duration is very short, so such an injection can be completed before the pressure in the combustion chamber 5 reaches a critical value.

Now, for the injection of the hydrogen, an angular range should therefore be used that is later than 40° of crankshaft angle after the closing of the air inlet valve 6. It is thereby advantageous to select the latest possible angular range, as this allows for efficient operation of the internal combustion engine without knocking. For selecting the angle used for the start of the injection, or the angular range for the injection, the pressure in the combustion chamber, due to compression after the air inlet valve 6 closes, must be taken into account.

Furthermore, the amount of hydrogen injected should likewise be taken into account for the angular range of the injection. Depending on the amount of hydrogen injected, it may make sense to move the start of the injection to an earlier or later point in time.

Furthermore, the combustion may also be influenced by selecting an appropriate center of combustion. The center of combustion may be influenced in particular by selecting an appropriate ignition angle.

All these measures serve to enable efficient operation of the internal combustion engine while preventing the occurrence of knocking.

1-8. (canceled)

9. A method for operating an internal combustion engine, the method comprising:
directly injecting hydrogen into a combustion chamber of the internal combustion engine, the hydrogen being injected in an angular range later than 40° of crankshaft angle after closing an air inlet valve of the internal combustion engine.

10. The method according to claim 9, wherein the angular range for the injection is selected to be as late as possible.

11. The method according to claim 10, wherein, for the selection of the angular range, pressure in the combustion chamber due to compression after the closing of the air inlet valve is taken into account.

12. The method according to claim 10, wherein, for the selection of the angular range, an amount of hydrogen injected is taken into account.

13. The method according to claim 10, wherein, for the selection of the angular range, a center of combustion of the hydrogen is taken into account.

14. The method according to claim 13, characterized in that the center of combustion is influenced by selecting an ignition angle of combustion.

15. The method according to claim 10, wherein, for the selection of the angular range, a knock susceptibility of a combustion is taken into account.

16. A device for operating an internal combustion engine using hydrogen injected directly into the combustion chamber of the internal combustion engine, the device being configured to cause the injection of the hydrogen in an angular range later than 40° of crankshaft angle after closing an air inlet valve of the internal combustion engine.

17. The device according to claim 16, wherein the device comprises a control device configured to generate signals to cause the injection of the hydrogen in the angular range later than 40° of crankshaft angle after the closing of the air inlet valve of the internal combustion engine.
